(19) United States
(12) Patent Application Publication
(10) Pub. No.: US 2013/0290007 A1
(43) Pub. Date: Oct. 31, 2013

(54) AUTOMATED PROACTIVE HEALTHCARE SERVICE AND PAYER BASED PATIENT SCHEDULING SYSTEM

(71) Applicants: Mahmud Haq, Franklin Park, NJ (US); Ata-ul-Hadi Chaudhry, Islamabad (PK); Stephen Synder, Oakland, NJ (US); Muhamman Imran Khan, Rawalpindi (PK); Najima Akram, Islamabad (PK)

(72) Inventors: Mahmud Haq, Franklin Park, NJ (US); Ata-ul-Hadi Chaudhry, Islamabad (PK); Stephen Synder, Oakland, NJ (US); Muhamman Imran Khan, Rawalpindi (PK); Najima Akram, Islamabad (PK)

(73) Assignee: MEDICAL TRANSCRIPTION BILLING, CORP., Somerset, NJ (US)

(21) Appl. No.: 13/548,842

(22) Filed: Jul. 13, 2012

Related U.S. Application Data
(60) Provisional application No. 61/638,662, filed on Apr. 26, 2012.

(51) Int. Cl. G06Q 50/22

(52) U.S. Cl. 705/2

(57) ABSTRACT

The automated proactive healthcare service and payer based patient scheduling system proactively generates communications to patients with the purpose of scheduling medically appropriate, reimbursable healthcare services. The process utilizes a rules based system to identify patients contained in respective healthcare provider's practice management and patient databases. The system will identify patients eligible for certain healthcare services including but not limited to well-care visits, annual check-ups, and immunizations. The data analyzed by the system includes but is not limited to historical healthcare provider-patient service dates, historical payer reimbursement details, patient demographic data, and payer reimbursement/eligibility details. Those patients identified as eligible for healthcare services will be sent an automated interactive communication regarding that healthcare service to facilitate the scheduling process. The communication is automatically generated by the system and can take any known form including but not limited to voice communication, electronic communication and text communication.

### CROSS-REFERENCE TO RELATED APPLICATIONS

This application claims the benefit of and priority to U.S. Provisional Application No. 61,638,662, filed on Apr. 26, 2012, which is entirely incorporated herein by reference in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL ON COMPACT DISC

Not Applicable

### BACKGROUND OF THE INVENTION

1. Field of the Invention

The invention relates to the technical field of data processing and corresponding methods thereof for the retrieval and analysis of data stored in a database, computer software, and automated communication services for providing a service to assist medical practices and patients in managing and scheduling healthcare services. As a result of the retrieval and analysis of data, communications are initiated to patients with the goal of scheduling medically appropriate healthcare services. The disclosure relates to exemplary embodiments regarding communication services for medical practices and patients.

2. Background

Historically, healthcare professionals have relied on manual techniques for the management of their medical practices with regard to such matters as scheduling healthcare services, patient record management, payer and eligibility determinations, as well as treatment tracking. These manual techniques have become increasingly impractical as medical treatment and healthcare provider coordination have become more complex and payer coverage and eligibility determinations have become less intuitive and more nuanced. In many circumstances, patients may be eligible for important healthcare services that are covered by their particular payer coverage, yet remain unaware of the importance of same or the fact that they are covered under the plan. Considering the challenges, these opportunities for patients to obtain the medically appropriate care that is covered by their plan, and for which healthcare providers have the resources and interest in providing, may go underutilized to the detriment of both the respective patient and healthcare provider.

In recent years, the utilization of electronic health record (EHR) and practice management (PM) systems has reduced some of this burden on healthcare providers. These systems, hardware and software, are known. Medical Transcription Billing Corp. (MTBC), the assignee of the present invention, has been offering such systems and related services for years. The present invention seeks to expand on the functionality and services that can be provided by these systems by implementing a system to determine which patients are proactively eligible for certain healthcare services and providing a method for the patients to easily schedule an appointment or service. MTBC has utilized technology in the past to provide patients with a reminder of an upcoming visit, and while a beneficial feature for the patient and the healthcare provider, this appointment reminder service primarily served to reduce the number of missed appointments. While this increased efficiency for healthcare providers by ensuring patients were reminded of their upcoming scheduled appointments, the service failed to recognize additional opportunities for patients to take advantage of certain healthcare services that, while medically appropriate and covered by their payer coverage, may be overlooked by healthcare providers and patients.

Consequently, unfulfilled by those prior systems and services is a system and method that will automatically extract from various patient or PM databases data including at least one, but not limited to patient demographic, scheduling, reimbursement, and payer coverage and analyze the data to identify medically appropriate and reimbursable healthcare services. Additionally, to address the issue of patient knowledge, a system is needed that will automatically communicate this eligibility to the patient and provide a simple, direct, and automated means of scheduling an appointment for the respective healthcare service. Such a system would significantly reduce the scenarios wherein patients and providers are unaware of the aforementioned, covered healthcare services, and would result in the scheduling and performance of healthcare services that would not have been undertaken but for the operation of the present invention. The net result of the above will be the optimization of the healthcare providers' resource utilization and revenues and an improvement in patient care resulting from the timely provision of medically appropriate healthcare services that might otherwise go unidentified and unperformed.

### BRIEF SUMMARY OF THE INVENTION

An automated proactive healthcare service and payer based patient scheduling system comprising of one computing server having a local patient database storing patient relevant data, and a local healthcare provider database storing healthcare provider relevant data. The computing server also comprises of a healthcare service eligibility computer program utilizing a healthcare service coverage rule set and one or more external sources to determine whether patients are eligible for healthcare service based on the payer's plan. The computing server further comprises of a payer eligibility computer program utilizing patient relevant data to determine the payer eligibility of the patient. The computing server also comprises of a scheduling rule set that proactively schedules patient according to healthcare provider's input and one or more external sources. In addition, the automated proactive healthcare service and payer based patient scheduling system has one communication server having an automated text generator generating patient and/or healthcare provider specific messages, and a communication program contacting the patient. The automated proactive healthcare service and payer based scheduling system also comprises of one or more external sources having all relevant data known in the art.

Other embodiments of the automated proactive healthcare service and payer based patient scheduling system may include one or more of the following features including but not limited to a recorded call server recording the communication with the patient, a response computer program analyzing the patient's response on the communication server, and a text-to-speech engine converting text-to-speech for communication.

Embodiments of the automated proactive healthcare service and payer based scheduling method may include generating a local patient database, a local healthcare provider database and a healthcare service coverage rule set on a computing server, determining healthcare service eligibility on the computing server, determining payer eligibility on the computing server, proactively scheduling patients based on the scheduling rule set on the computing server, generating patient and/or healthcare provider specific messages on a communication server, and contacting patients on the communication server.

Other embodiments of the automated proactive healthcare service and payer based scheduling method may include one or more of the following steps including but not limited to the step of recording a call on one recorded call server, the step of analyzing the patient's response on one communication server, and the step of translating text-to-speech on one communication server.

In another aspect of the invention, embodiments of the automated proactive healthcare service and payer based patient scheduling system may include a first computing server having a local patient database and a local healthcare provider database. Embodiments of the automated proactive healthcare service and payer based patient scheduling system may also include a second computing server having a healthcare service eligibility computer program utilizing the local patient database and a healthcare service coverage rule set. Embodiments of the invention may include a third computing server having a payer eligibility computer program utilizing one external source. The automated proactive healthcare service and payer based patient scheduling system may also include a fourth computing server having a scheduling rule set proactively scheduling patients. Embodiments of the automated proactive healthcare service and payer based patient scheduling system may include a first communication server having an automated text generator generating patient and/or healthcare provider specific messages, and a second communication server having a communication program contacting a patient.

In other embodiments the automated proactive healthcare service and payer based patient scheduling system may include one or more of the following a third communication server maintaining a response computer program analyzing the patient's response, a recorded call server recording communication, and the first communication server maintaining a text-to-speech engine.

One aspect of the invention embodies an automated proactive system and method for specific payer eligibility identification, communication, and scheduling service oriented towards reducing the missed opportunities for certain healthcare services. The system will not only determine which patients are eligible for certain healthcare services, but also generate a communication to concerned patients regarding their eligibility, prompting them to schedule an appointment and facilitating the scheduling of the related healthcare services. The invention aims for a healthier society by ensuring that each patient receives certain often overlooked healthcare services, such as annual well visits and immunizations that are critical to their long-term care.

### BRIEF DESCRIPTION OF THE SEVERAL VIEWS OF THE DRAWINGS

FIG. 1 depicts a functional block diagram of an embodiment of an automated proactive healthcare service and payer based patient scheduling system.

FIG. 2 depicts a functional block diagram of another embodiment of an automated proactive healthcare service and payer based patient scheduling system with a recorded call server.

FIG. 3 depicts a functional block diagram of another embodiment of an automated proactive healthcare service and payer based patient scheduling system with a response computer program and a recorded call server.

FIG. 4 depicts a functional block diagram of another embodiment of an automated proactive healthcare service and payer based patient scheduling system with a text-to-speech engine, a response computer program, and a recorded call server.

FIG. 5 depicts an exemplary flowchart showing an automated proactive healthcare service and payer based scheduling method.

FIG. 6 depicts an exemplary flowchart showing an automated proactive healthcare service and payer based scheduling method with a recorded call server.

FIG. 7 depicts an exemplary flowchart showing an automated proactive healthcare service and payer based scheduling method with a recorded call server, and a response computer program.

FIG. 8 depicts an exemplary flowchart showing an automated proactive healthcare service and payer based scheduling method with a recorded call server, a response computer program and a text-to-speech engine.

FIG. 9 depicts a functional block diagram of another embodiment of an automated proactive healthcare service and payer based patient scheduling system with individual servers maintaining the system.

FIG. 10 depicts a functional block diagram of another embodiment of an automated proactive healthcare service and payer based patient scheduling system with individual servers and a recorded call server.

FIG. 11 depicts a functional block diagram of another embodiment of an automated proactive healthcare service and payer based patient scheduling system with individual servers, a recorded call server, and a response computer program.

FIG. 12 depicts a functional block diagram of another embodiment of an automated proactive healthcare service and payer based patient scheduling system with individual servers, a recorded call server a response computer program and a text-to-speech engine.

FIG. 13 is a screenshot of an embodiment of an external source that allows healthcare providers to subscribe to the automated proactive scheduling system.

### DETAILED DESCRIPTION OF THE INVENTION

Detailed embodiments of the present invention are disclosed herein, however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the present invention.

Described herein are embodiments of an automated proactive healthcare service and payer based patient scheduling system and method thereof. Embodiments of the system will not only determine which patients are eligible for certain healthcare services, but may also generate a communication to concerned patients regarding their eligibility, prompting them to schedule an appointment and facilitate the scheduling of the related healthcare services. The system is designed to easily integrate with a medical office management software suite or service such as but not limited to a PM system. Embodiments of the present invention may be hosted locally, remotely or on the web, and provide healthcare providers and their staff with the features necessary to alleviate the burden of many tedious tasks including at least one of scheduling, billing management, patient information management, coverage and eligibility determinations and claim submissions.

Related to and utilized by many PM systems are EHR systems, which can also operate without a PM system. EHR systems are known in the art, and have been used to communicate patient health information across remote systems, allowing the communication and integration of multiple systems and databases. Information that can be compiled in an EHR includes data related to laboratory tests, prescription and drug treatment, appointment history, claim history, payer information, billing history, as well as history of diagnosis and related healthcare providers. EHR systems focus on the total health of the patient by going beyond the standard clinical data of a patient. EHR systems are designed to reach out beyond the health organization that originally collects and records the information. EHR systems are designed and built to share information with multiple healthcare providers to facilitate coordination of care. This communication and integration has resulted in an increase in efficiency for healthcare providers and related healthcare services. The present invention may take advantage of both PM and EHR systems to provide additional benefits to patients and the healthcare providers. Disclosed embodiments of the invention are designed to ensure that patients are on notice and given the opportunity to take advantage of various healthcare services and healthcare services that are beneficial and covered by their payer plan.

Performing automated proactive healthcare service and payer based scheduling with the embodiments of the present system may provide a number of advantages. The use of embodiments of the automated proactive healthcare service and payer based scheduling system may reduce any delay in communication between healthcare provider and patient. The use of embodiments of the automated proactive healthcare service and payer based scheduling system may also streamline the reimbursement process between healthcare provider and the payer. The use of embodiments of the automated proactive healthcare service and payer based scheduling system may allow patients with more information regarding payer and healthcare provider, such that the patient may make informed decisions regarding the healthcare service, and scheduling with healthcare provider. Embodiments of the automated proactive healthcare service and payer based scheduling system may assist healthcare providers to increase revenues, and reduce manual work.

In one aspect, an embodiment of the healthcare service and payer based scheduling system may include a computing server, a communication server and one or more external sources. The computing server and the communication server may be of any operating system such as but not limited to Windows ME, WindowsNT, Windows XP, Windows based, Linux based, or Apple based system and the like. The servers may be able to perform storage, network communication and processing functions. The servers may include one or more of computer systems such as but not limited to a minicomputer or personal computer. The servers may be of any type such as but not limited to proxy servers, mail servers, web servers, and application servers or any combination thereof.

The computing server may receive information from one or more external sources. Such external sources may include but not be limited to the internet, data entered via users and/or various remote databases. The various remote databases may include but are not limited to remote practice management databases, remote third party patient databases, and/or remote third party insurance databases. Embodiments of the external source may include clearinghouses known in the art and various web-based portals such as but not limited to Emdeon, Navinet, Availity or directly from the payers. Payers may include but are not limited to governmental payers, commercial payers and the like. Governmental payers may include but are not limited to Medicaid, Medicare and the like. Commercial payers may include but are not limited to [insert different commercial payers] and the like. Third-party services allow access to their databases and offer real-time and batch integration. Similarly, for eligible patients whose identified coverage is government healthcare programs, one external source may be third-party services such as IVANS. Other external sources may be data inputted by users such as but not limited to healthcare providers concerning office hours, payer coverage limitations, patient contact availability and health provider contact availability. Information that may be transmitted includes but is not limited to patient information, healthcare provider information, payer information, testing information, and the like. Embodiments of the automated proactive healthcare service and payer based scheduling system may include one or more external sources that provide information to the computing server, and other elements of the system via various methods. Transports for information exchange include but are not limited to wire line or wireless networks including fiber, Ethernet, internal and external bus, Peripheral Component Interconnect (PCI) and the like.

The computing server may maintain a local patient database, and a local healthcare provider database. These databases may be any of a variety of systems configured to manage data. These databases may be implemented software, tables or a combination thereof. These databases are in some form such as but not limited to Oracle, Sybase, Microsoft, SQL, and MySQL and the like. The local patient database may store information on any patient relevant data. The local patient database may store information such as but not limited to patient information such as date of birth, gender, address, medical conditions, medications and drug prescriptions, treatment history, scheduling information and the like. The local healthcare provider may store information on any healthcare provider relevant data. The local healthcare provider database may include healthcare provider information such as contact information, location of healthcare provider, testing information and the like. These databases may also allow for a more organized, and easily accessible amount of voluminous data. The data maintained in these databases may be acquired from one or more external sources. These databases may accumulate data, repeatedly update data and be frequently accessed by the other elements of the system.

Embodiments of the computing server may include a healthcare service eligibility computer program, and a payer eligibility computer program. These computer programs may be any suitable program with a sequence of coded instructions which are to be inserted into a computer well known to those skilled in the art. These computer programs may be loaded on the random access memory (RAM) on the computing server. These computer programs may be coded by a person known in the art with multiple languages such as but not limited to Java, C, C++, and the like. Embodiments of the computing server may also combine the functions of the payer eligibility computer program, and the healthcare service eligibility computer program into one or more computer programs on the computing server. These computer programs may repeatedly update data and be frequently accessed by the other elements of the system.

One aspect of healthcare service eligibility computer program may utilize information from the healthcare service coverage rule set and the local patient database. The information utilized by the healthcare service coverage rule set may include payer information, healthcare service information and the like. In a preferred embodiment, the healthcare service eligibility computer program may organize patient information based on the healthcare service coverage rules. In other embodiments, the healthcare service eligibility computer program may organize patient information based on patient information, medical provider information, and the like. The healthcare service eligibility computer program may filter patient information by their eligibility for healthcare services for different payers. The healthcare service eligibility computer program may determine whether patient is eligible for certain healthcare services and whether payer covers that healthcare service. In addition, the healthcare service eligibility computer program may utilize the information from the local patient database and the healthcare service coverage rule set to determine whether patient is eligible by the payer for certain healthcare services. The healthcare service eligibility computer program may maintain constant communication with the local patient database and the healthcare service coverage rule set to update their respective information. The healthcare service eligibility computer program then may communicate the healthcare service eligible patient to the scheduling rule set for scheduling and/or the payer eligibility computer program to further analyze the data.

Embodiments of the computing server may maintain a healthcare service coverage rule set to be used along with the healthcare service eligibility computer program. The healthcare service coverage rule set may be coded by a person known in the art with multiple languages such as but is not limited to Java, C, C++, and the like. The healthcare service coverage rule set may also obtain information from one or more external sources. Such information may include but is not limited to healthcare service information, payer coverage information, payer coverage dates, and payer information. The healthcare service coverage rule set may contain rules of the requirements for certain healthcare services relative to different payers. In a preferred embodiment, the healthcare service coverage rule set may be a set of parameters that are generated to determine which healthcare services are covered by the payer's coverage. The healthcare coverage rule set may be frequently accessed, and repeatedly updated by one or more external sources, and/or a person known in the art.

One aspect of embodiments of payer eligibility computer program may utilize information from one or more external source, and the healthcare service eligibility computer program. The information utilized by the payer eligibility computer program may include but is not limited to healthcare service eligibility information, healthcare provider information and payer information and the like. Utilizing the external source, the payer eligibility computer program may determine whether patient is covered by payer, patient's reimbursement history, death status of the patient, whether patient already received care and the like. The payer eligibility computer program may maintain constant communication with healthcare service eligibility computer program and one or more external sources to update their respective information. In a preferred embodiment, the payer eligibility computer program will determine whether patient is covered by payer based on the external source and the local patient database. The payer eligibility computer program may also determine whether patient is still eligible for payer's coverage based on the prior medical history, patient's reimbursement history, death status of the patient and the like. Based on the above standards, the payer eligibility computer program may determine whether the patient is eligible for payer's coverage. When a patient is determined healthcare service eligible and payer eligible, this information may be communicated to the scheduling rule set for scheduling and/or the healthcare service eligibility computer program for further analysis.

One aspect of embodiments of the scheduling rule set may utilize information provided by the healthcare service eligibility computer program, the payer eligibility computer program and one or more external sources. The embodiments of the scheduling rule set may be coded by a person known in the art with multiple languages such as but not limited to Java, C, C++, and the like. The information provided to the scheduling rule set may include but not limited to patient information, healthcare coverage information, payer information and the like. In this embodiment, the scheduling rule set may utilize information provided by one or more external sources to determine the availability of healthcare providers to proactively schedule a healthcare service eligible and payer eligible patient. The scheduling program may access one or more external sources for updated information on healthcare provider availability prior to scheduling. In one instance, if the scheduling rule set determines that healthcare provider is not available for contact, information on the healthcare service eligible and payer eligible patient may not be sent to the communication server. On the other hand, if scheduling rule set determines that healthcare provider is available and that a patient is healthcare service eligible and payer eligible, this information may be sent to the communication server.

Embodiments of communication server may include an automated text generator and a communication program. One aspect of the communication server may be an IVR server or the like. Both automated text generator and communication program may be loaded on the RAM on the communication server. An embodiment of the automated text generator may generate text using multiple sources such as but not limited to the local patient healthcare database, the scheduling rule set, the local patient database and the like. The automated text generator may create strings of variables utilizing the information above and create predefined messages designed by developers. The predefined messages may incorporate patient information, healthcare service information, payer information and the like. The automated text generator may be coded by a person known in the art with multiple languages such as but not limited to Java, C, C++, and the like.

An embodiment of the communication program may allow for the patient or healthcare provider specific text to be communicated to a patient. The communication program may communicate via written communication, voice communication, electronic communication, and any other communication method. The communication program may be one known in the art such as Asterisk software. Asterisk software is a communication program known in the art, which allows users to communicate to an end client via electronic communication, written communication, voice communication and the like. The communication program may include code for sending and receiving emails. In a preferred embodiment, the communication program may provide the patient with healthcare provider information that will connect them to the appropriate healthcare provider or connect them with a link to an external site.

Embodiments of the automated proactive healthcare service and payer based scheduling system may include at least one or a combination of the following elements: a recorded call server, a response computer program on the communication server, and a text-to-speech engine on the communication server.

An embodiment of the recorded call server may allow the communication between the communication program and patient to be recorded. The recorded call server may record in multiple formats such as but not limited to text recording, and voice recordings. The recorded call server may also perform storage, network communication processing functions, and playback communication. The recorded call server may be of any operating system such as, but not limited to, WindowsME, WindowsNT, Windows XP, Windows based, Linux based, or Apple based system and the like. The calls may be recorded in any format known in the art such as, but not limited to, *.wav, *.mid, *.txt and *.mp3. The recorded call server may provide quality assurance practice and review the automated proactive healthcare service and payer based scheduling service.

Embodiments of the response computer program may analyze the patient's response. The response computer program may be loaded on the RAM of the communication server. The response computer program may be able to analyze the patient's reply to the communication sent by the communication program. The response may include information including, but not limited to, scheduling information, healthcare provider information, and patient information. This response computer program then communicates to the communication program that will contact the patient with the corresponding response.

The text-to-speech engine on the communication server may allow text to be converted into speech to be communicated to the patient. The text-to-speech engine may utilize NeoSpeech, and the like. The text-to-speech engine may be used along with the automated text generator prior to being sent to the communication program. The text-to-speech engine will assist the automated text generator to complete common phrases and automatically generate patient specific messages, healthcare provider specific messages or a combination thereof.

The order in which the method is described is not intended to be construed as a limitation and any number of the described method blocks can be combined in any order to implement the method or an alternate method. Additionally individual blocks may be deleted from the method without departing from the spirit and scope of the subject matter described herein. Furthermore the method can be implemented in any suitable hardware, software, firmware or combination thereof.

Embodiments of the automated proactive healthcare service and payer based scheduling method may include the following steps: generating a local patient database, a local healthcare provider database and a healthcare service coverage rule set; determining healthcare service eligibility; determining payer eligibility; proactively scheduling patients; automatically generating text; and contacting patients. In one aspect, the step of generating a local patient database, a local healthcare provider database, and a healthcare service coverage rule set is done by extracting relevant information in one or more external sources. The external source may be any such source known in the art as described above. The next step of determining healthcare service eligibility may be based on the healthcare service coverage rule set and the local patient database. The healthcare service eligibility computer program may utilize information by these respective systems to determine whether patient is eligible for certain healthcare services based on the payer coverage. The step of determining payer eligibility which is also based on at least one external source and this step will use information to determine patient's payer coverage and/or may use their medical history to determine if patient has already received care. The step of proactively scheduling patients will use the scheduling rule set and the external source to determine whether healthcare provider is available for contact prior to scheduling patients. Embodiments of the automated proactive healthcare service and payer based scheduling method may include the step of automatically generating text and the step of communicating with patients. The step of automatically generating text will generate patient and/or healthcare provider specific messages based on information by the local patient database, the local healthcare provider database, and the scheduling rule set. Finally, the step of contacting the patient will use the communication program to contact the patient via electronic communication, written communication or voice communication.

Embodiments of the automated proactive healthcare service and payer based scheduling method may include at least one or a combination thereof of the following steps: recording communication with the patient; analyzing patient's response; and translating text-to-speech. Embodiments of the automated proactive healthcare service and payer based scheduling method may include steps of analyzing the patient's response and translating text-to-speech on a communication server. Embodiments of the automated proactive healthcare service and payer based scheduling method may include the step of recording communication with the patient on a recorded call server. The step of analyzing patient response will analyze patient's response and generate a response that will be forwarded to the communication program.

Another embodiment of the automated proactive healthcare service and payer based scheduling system may include four computing servers, two communication servers and one external source. One aspect of the embodiments of the four computing servers may maintain a first computing server housing a local patient database and local healthcare provider database. The local patient database and local healthcare provider database are gathering patient and healthcare provider relevant data from external sources. Embodiments of a second computing server may maintain a healthcare service eligibility computer program and a healthcare service coverage rule set. The healthcare service eligibility computer program determines whether patient is covered for certain healthcare services based on the healthcare service coverage rule set, and local patient database. Embodiments of the third computing server may maintain a payer eligibility computer program. The payer eligibility computer program determines whether patient already received that treatment from external sources. One aspect of the embodiments of a fourth computing server may maintain a scheduling rule set. The scheduling rule set will use healthcare provider input on the date and time that provider is available for contact. Embodiments of a first communication server may maintain an automated text generator. The automated text generator generates patient specific text for communication. Embodiments of a second communication server may maintain a communication program. The communication program contacts patients via electronic communication, voice communication and text communication or any combination thereof.

Embodiments of the automated proactive healthcare service and payer based scheduling system may maintain at least two servers which transfer information over variety of possible transports. Transports for information exchange include, but are not limited to, wire line or wireless networks including fiber, Ethernet, internal and external bus, Peripheral Component Interconnect (PCI) and the like.

### The System Overview

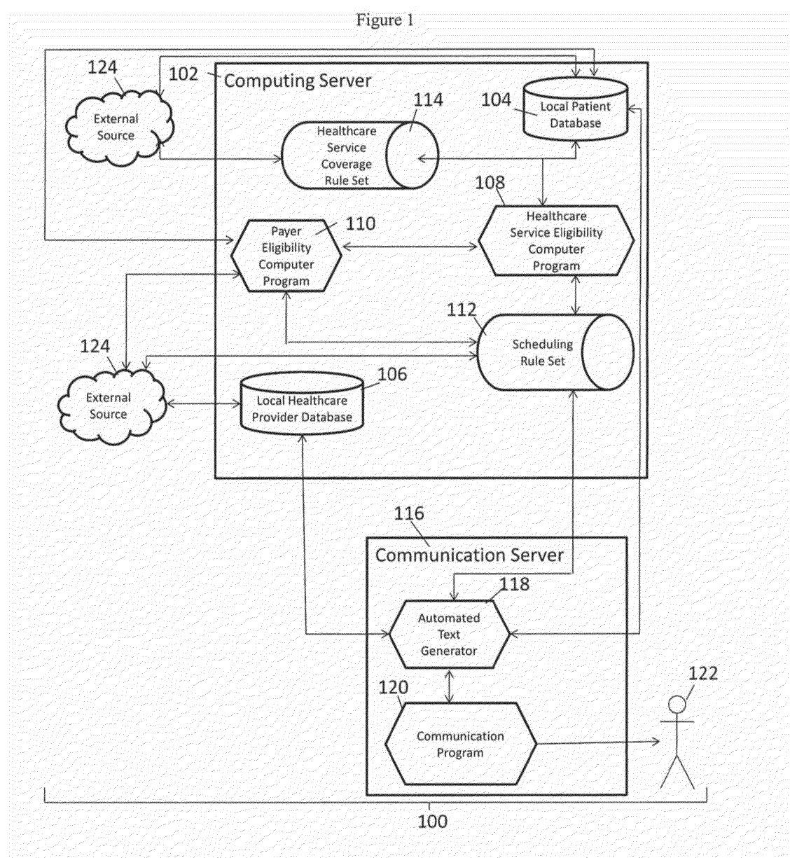

FIG. 1 is an exemplary block diagram of an automated proactive healthcare service and payer based scheduling system 100. In this embodiment, the processing for the system takes place on a centrally hosted computing server 102. The computing server 102 extracts data from various fields within the database. The computing server 102 extracts data from a number of different databases including a local patient database 104, a local healthcare provider database 106, and healthcare service coverage rule set 114. The data generated for these databases may originate outside of the computing server 102, which is shown as an external source 124. From this communication, the local patient database 104 updates patient EHR information and data. The local healthcare provider database 106 contains healthcare provider contact information, and other healthcare provider information that is aggregated from the external source 124. The external source may include but is not limited to PM systems, EHR systems, and the like. The external source 124 also includes payer information, healthcare service information, patient information and the like.

FIG. 1 also shows an embodiment of the computing server 102 that maintains a healthcare service eligibility computer program 108, an payer eligibility computer program 110 and a scheduling rule set 112. In a preferred embodiment, the healthcare service eligibility computer program 108 utilizes the local patient database 104 and the healthcare service coverage rule set 114 to determine whether patient 122 is healthcare service eligible by the payer to receive care for certain healthcare services. The patient 122 is determined eligible for these healthcare services based on the healthcare service coverage rule set 114 developed by those known in the art. The healthcare service eligibility computer program 108 filters patient data, and payer data to determine whether patient is eligible for the healthcare service. The healthcare service eligibility computer program 108 may also use information pertaining to payer coverage, and patient information to determine whether patient 122 is healthcare service eligible. Once patient 122 is determined to be healthcare service eligible, the healthcare service eligibility computer program 108 communicates with the payer eligibility computer program 110 to determine whether patient is payer eligible. The healthcare service eligibility computer program 108 may also communicate to the scheduling rule set 112 to determine scheduling.

In this embodiment, the automated proactive healthcare service and payer based scheduling system 100 also draws on rules based on healthcare service and payer information, which is shown as a healthcare service coverage rule set 114. These rules are programmer developed and manually uploaded to the computing server 102. Any external source 124 can be used to develop these rules such as clearing houses including but is not limited to Emdeon, Navinet, and Availity. The rules developed by the programmer will contain information on which healthcare services are eligible based on payer information. As described above, in a preferred embodiment, the healthcare service coverage rule set 114 will be used along with the local patient database 104 with the healthcare service eligibility computer program 108.

One aspect of this embodiment, the payer eligibility computer program 110, may determine whether patient 122 is eligible for payer coverage by utilizing at least one external source 124 and the data from the healthcare service eligibility computer program 110. In a preferred embodiment, patient 122 will be eligible for healthcare service and payer based on patient information and payer information. In this embodiment, the external source 124 will comprise of data including remote insurance database, remote third party patient database and data of patient's visits. In other embodiments, the payer eligibility computer program 110 will use other information such as patient's medical history and the like. Based on this information, the payer eligibility computer program 110 will determine if patient 122 previously received care for the healthcare service by the healthcare provider based on the patient's medical history. Once patient 122 is determined to be payer eligible, the payer eligibility computer program will communicate with the scheduling rule set 112 to determine scheduling.

In this embodiment, the computing server 102 also has a scheduling rule set 112. The scheduling rule set 112 utilizes data from the healthcare service eligibility computer program 108, the payer eligibility computer program 110, and an external source 124 to proactively schedule a date and time to contact the patient 122. The scheduling rule set 112 receives information on patients that are healthcare service eligible and payer eligible by the healthcare service eligibility computer program 108 and the payer eligibility computer program 110 respectively. If patient 122 is healthcare service eligible and payer eligible, the scheduling rule set 112 will determine when to contact the patient 122 based on the external source 124 and send this data to the communication server 116. In this instance, the external source 124 may be user inputted data on healthcare provider's availability or determined based on healthcare provider's office hours.

FIG. 1 also shows an embodiment of the communication server 116 that maintains an automated text generator 118 and a communication program 120. One embodiment of the communication server 116 is an IVR server. The automated text generator 118 in the communication server 116 receives data from the local patient database 104, the local healthcare provider database 106, and the scheduling rule set 116. The automated text generator 118 utilizes the information provided by the above-mentioned components to generate patient and/or healthcare provider specific messages. The automated text generator 118 then communicates this information to the communication program 120 for communication.

One aspect of this embodiment, the communication program 120 is able to utilize the information provided by the automated text generator 118 to communicate to patient 122. In one embodiment, the communication program is Asterisk software, and the like. The communication program 120 is able to communicate to the patient 122 via electronic methods, audio methods and the like.

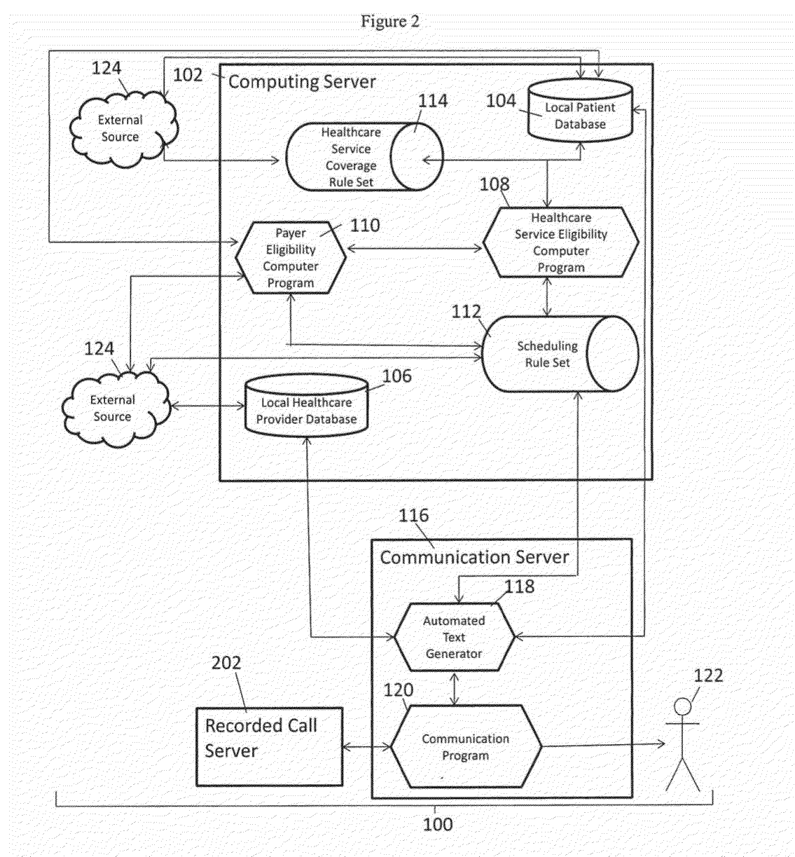

FIG. 2 shows another embodiment of the automated proactive healthcare service and payer based scheduling system 100 that utilizes a recorded call server 202. The recorded call server 202 has the ability to record calls and playback calls communicated by the communication program 120. The call recorded may be in either text or audio format. The recorded call server 202 is used to review user experience and improve the communication sent to the patient 122.

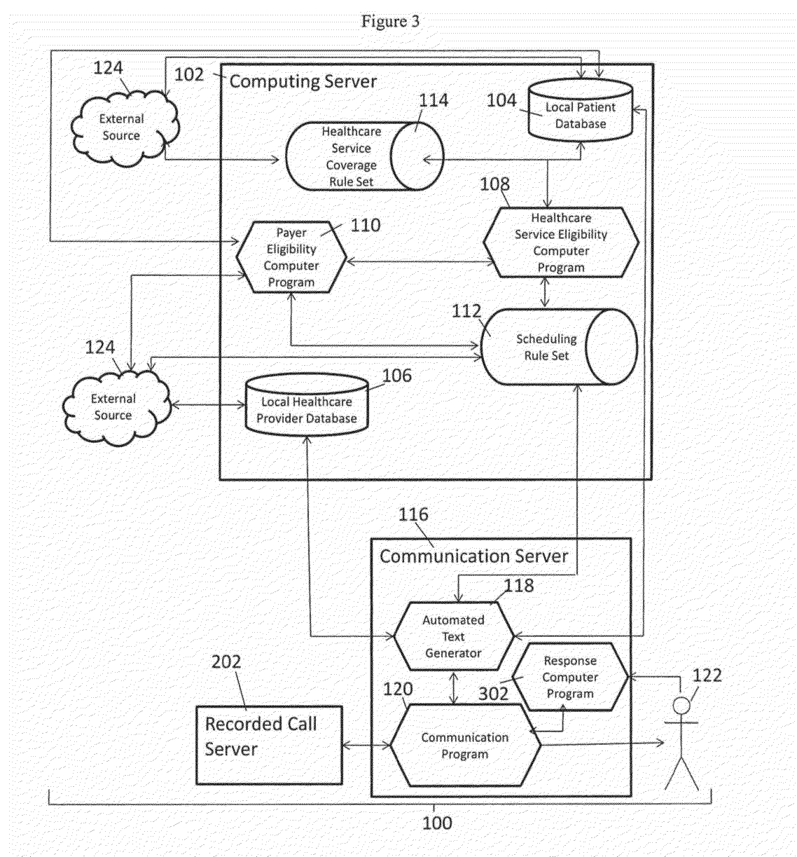

FIG. 3 shows another embodiment of the automated proactive healthcare service and payer based scheduling system 100 that maintains a recorded call server 202 and a response computer program 302. The response computer program 302 has the ability to analyze patient's responses and generate a reply which is forwarded to the communication program 120. The response computer program 302 will utilize information sent by the patient 122 to analyze how to respond to the reply.

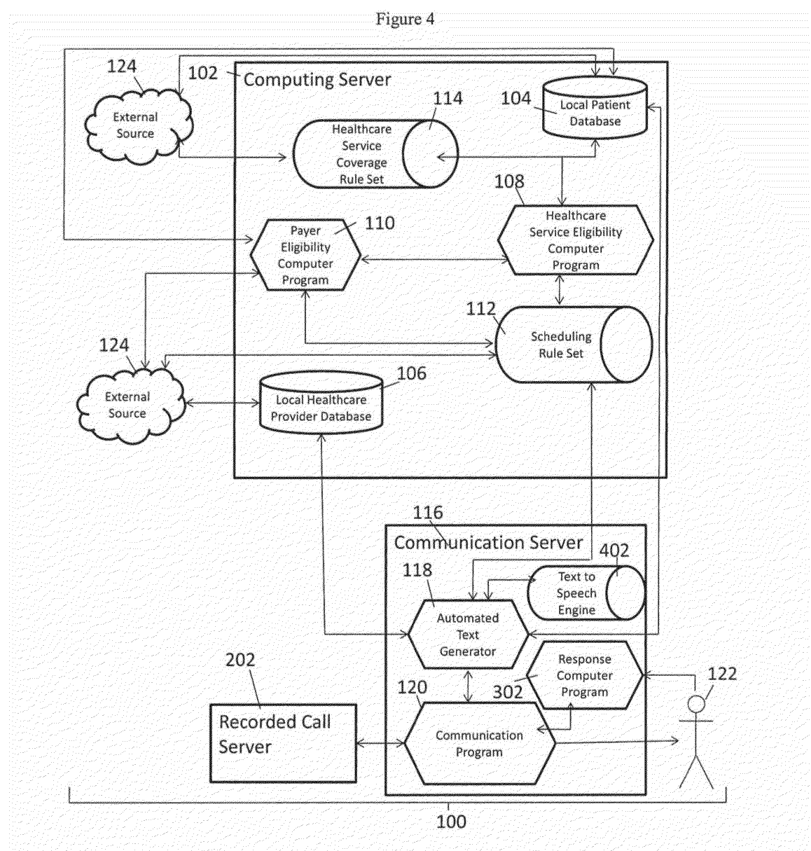

FIG. 4 shows another embodiment of the automated proactive healthcare service and payer based scheduling system 100 that utilizes a call recorded call server 202, a response computer program 302, and a text-to-speech engine 402. In this embodiment, the automated proactive healthcare service and payer based scheduling system 100 shows the text-to-speech engine 402 assisting the automated text generator 118 to complete phrases and fill in words to form complete sentences.

### The Method Overview

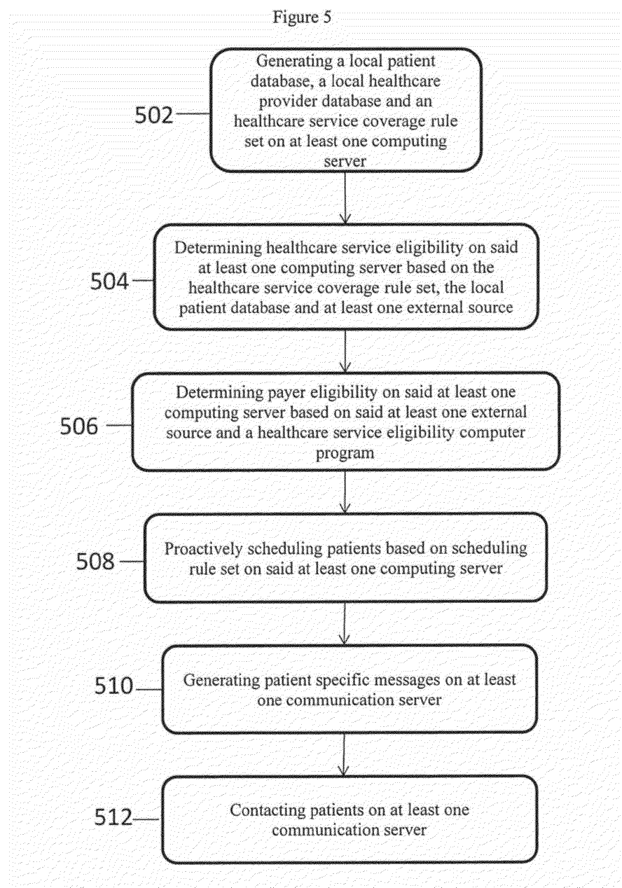

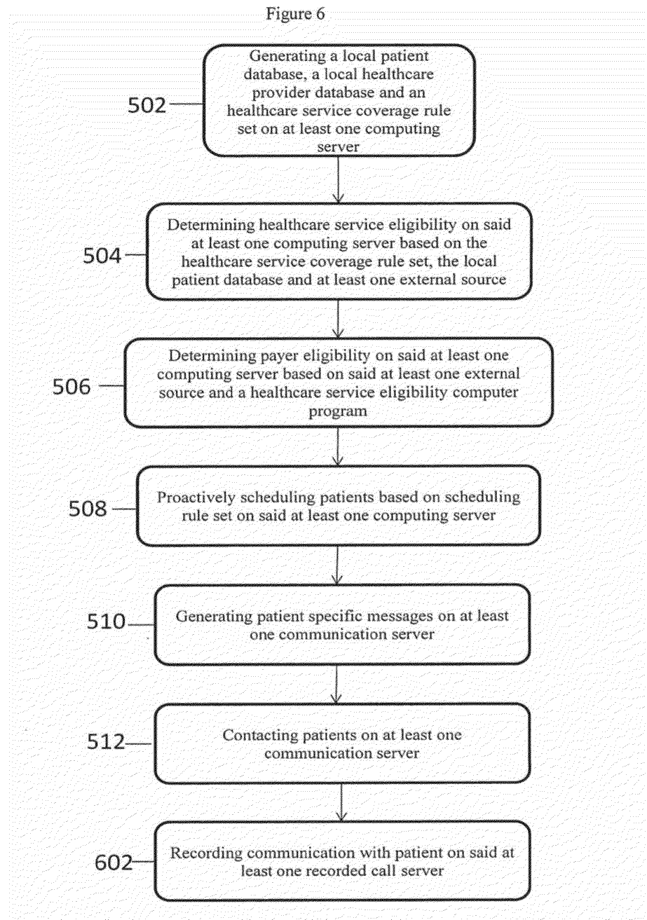

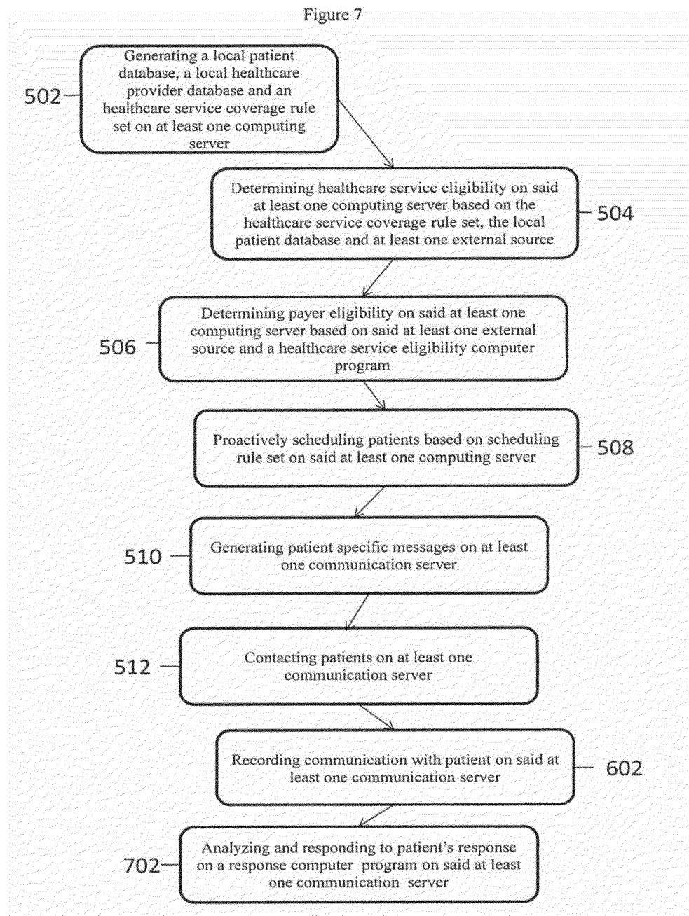

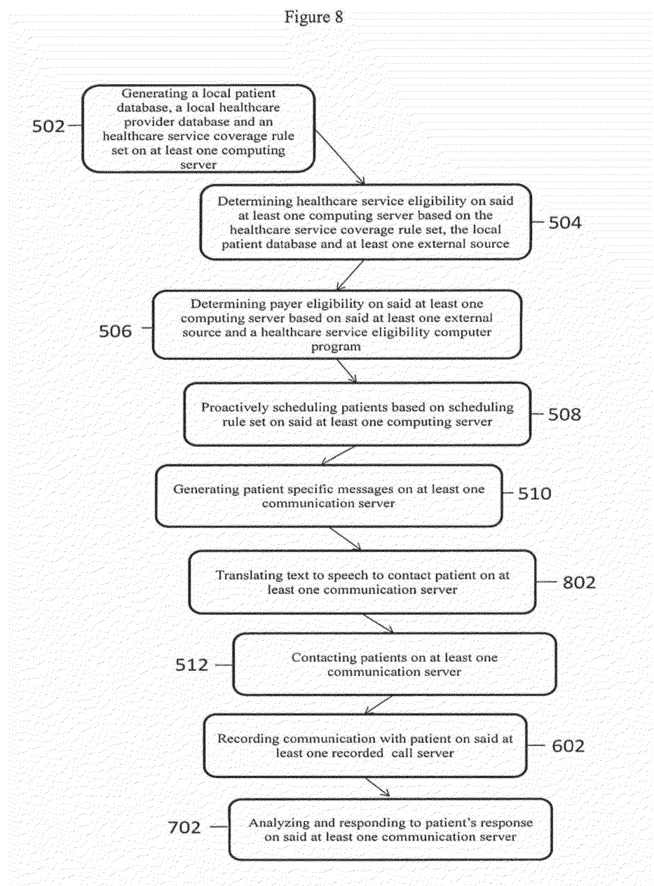

FIG. 5, FIG. 6, FIG. 7, FIG. 8 illustrates a number of steps, any steps may be added or removed, and the steps may be performed in any order. FIG. 5 shows a flowchart of the automated proactive healthcare service and payer based scheduling method utilizing the automated proactive healthcare service and payer based scheduling system 100. In step 502, the local patient database 104, the local healthcare provider database 106, and healthcare service coverage rule set 114 are built by using information from an external source 124. The external source 124 can be any source that maintains relevant data to each of the corresponding local patient database 104, local healthcare provider database 106 or healthcare service coverage rule set 114 as explained above. The next step 504, the healthcare service eligibility computer program 108, utilizes information on the local patient database 104 and the healthcare service coverage rule set 114 to determine whether patient 122 is eligible for healthcare services that is covered by their payer. Step 506, determines whether patient is eligible for payer coverage on the external source 124 and the healthcare service eligibility computer program 108. Information required for the payer eligibility computer program 110 is the patient information and healthcare provider information to determine whether patient is still covered by payer, the length of time the coverage lasts and whether patient has already received relevant care. In step 508, the scheduling rule set 112 proactively schedules patients for notice of their payer covered appointment. In step 510, the communication server 116 utilizes the automated text generator 118 to develop patient or healthcare provider specific messages. Step 512, the communication server 116 utilizes the communication program 120 to convey the specific messages to the patient 122.

FIG. 6, FIG. 7, FIG. 8, shows a flowchart of other embodiments of the automated proactive healthcare service and payer based scheduling method which may include at least one or a combination thereof of additional steps. FIG. 6 shows a flowchart of another embodiment of the automated proactive healthcare service and payer based scheduling method, where the step 602 is added. In step 602, the recorded call server 202 records the communication with the patient 122. The recording step 602 may occur in any format such as but is not limited to voice recording, and text recording.

FIG. 7 shows a flowchart of another embodiment of the automated proactive healthcare service and payer based scheduling method, where the step 702 is shown. Step 702 shows that the communication server 116 maintains a response computer program 302 to analyze the response by the patient 122.

FIG. 8 shows another embodiment of the automated proactive healthcare service and payer based scheduling method, where step 802 is added. In step 802, the communication server 116 maintains an additional element of the text-to-speech engine 402 which assists the automated text generator to generate patient and/or healthcare provider specific messages.

### Another Embodiment of the System

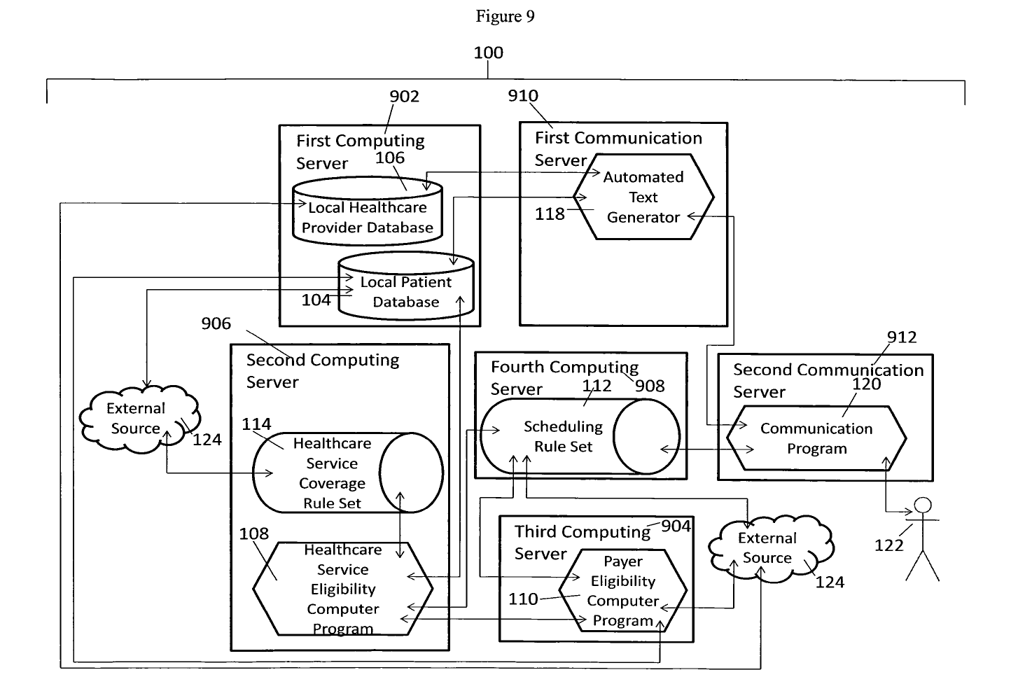

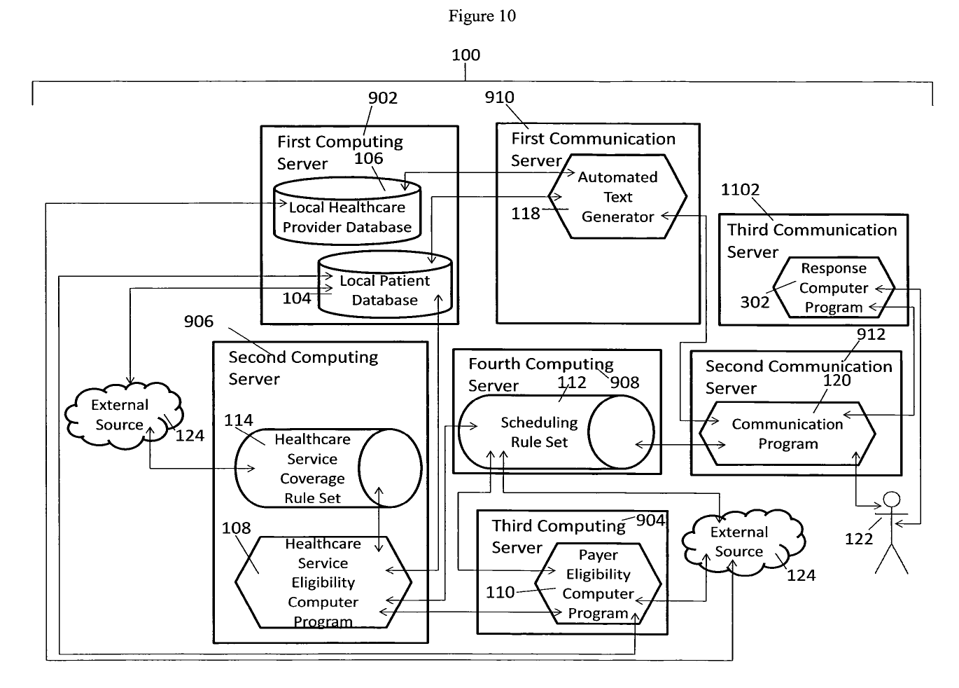

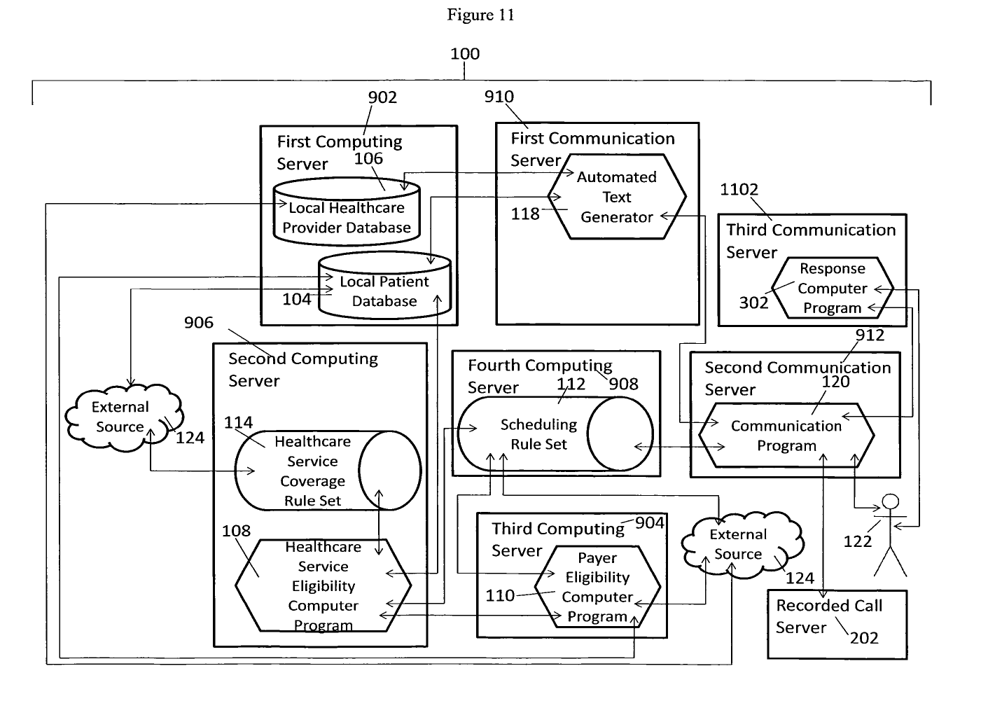

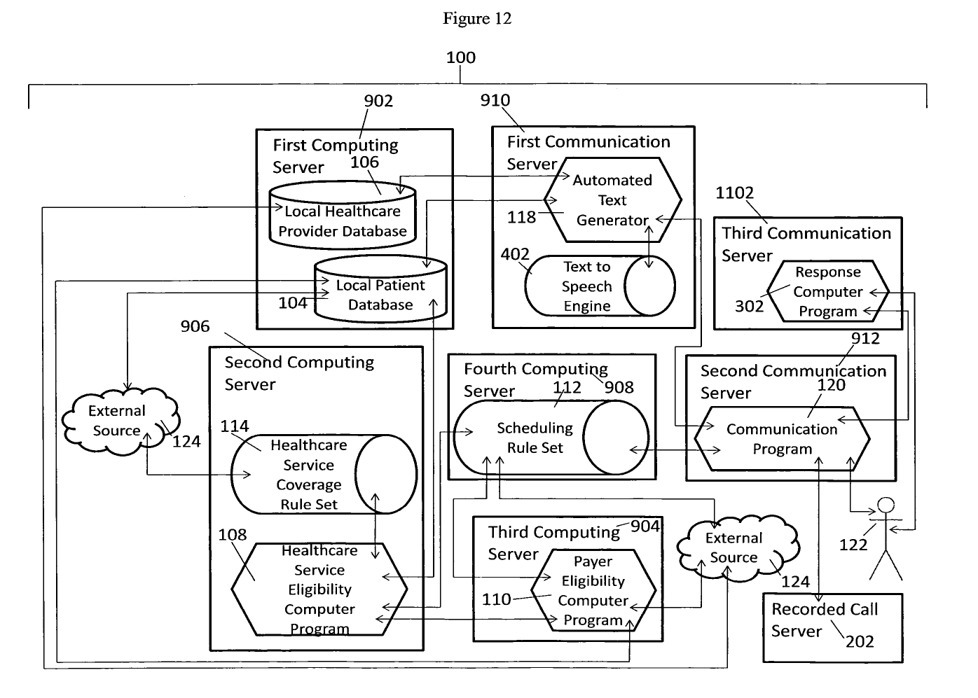

FIG. 9, FIG. 10, FIG. 11, FIG. 12 shows another embodiment of the automated proactive healthcare service and payer based scheduling system 100, where the system 100 is separated into individual servers to increase data storage and the speed of the automated proactive healthcare service and payer based scheduling system 100. FIG. 9 shows an embodiment of the automated proactive healthcare service and payer based scheduling system 100 where a first computing server 902 extracts relevant data from the external source 124 to store in the local patient database 104, and the local healthcare provider database 106. In this embodiment, a second computing server 904 stores the healthcare service eligibility computer program 108 and the healthcare service coverage rule set 114. The healthcare service eligibility computer program 108 utilizes information in the healthcare service coverage rule set 114 and the external source 124 to determine whether patient 122 is eligible for certain healthcare services. There also exists a third computing server 906, which stores the payer eligibility computer program 110. The payer eligibility computer program 110 utilizes the external source 124 to determine whether patient 122 is eligible for payer and/or has received care for certain healthcare services. Another element of this embodiment is a fourth computing server 908 that stores the scheduling rule set 112. The scheduling rule set 112 utilizes one or more external sources 124, the information from the healthcare service eligibility computer program 108 and the payer eligibility computer program 110 to determine whether healthcare provider is available and the healthcare service and payer eligible patient 122 can be contacted. In this aspect of the invention, there also exists a first communication server 910 and a second communication server 912. In this embodiment, the first communication server 910 maintains the automated text generator 118, which generates patient, and/or healthcare provider specific messages based on information from the local patient database 104, the local patient healthcare provider 106 and the scheduling rule set 112. In addition, the second communication server 912 maintains the communication program 120. The communication program 120 may contact patient 122 in multiple methods such as but is not limited to voice, messaging and electronic communication.

FIG. 10 shows another embodiment of the automated proactive healthcare service and payer based scheduling system 100. In this embodiment, the added element of recorded call server 202 is added to this embodiment of the automated proactive healthcare service and payer based scheduling system 100. The recorded call server 202 is recording the communication to the patient 122 by the communication program 120. The recorded call server 202 may record the communication to the patient in multiple formats such as but is not limited to audio recordings or text recording.

FIG. 11 shows another embodiment of the automated proactive healthcare service and payer based scheduling system 100, where the third communication server 1102 maintains a response computer program 302. The response computer program 302 has the ability to analyze and generate a response that is forwarded to the second communication server 912. The response computer program 302 will analyze patient's input and respond appropriately. In this embodiment, the automated proactive healthcare service and payer based scheduling system 100 also maintains the recorded call server 202 described above.

FIG. 12 shows another embodiment of the automated proactive healthcare service and payer based scheduling system 100, where the first communication server 910 also maintains a text-to-speech engine 402 that assists the automated text generator 118. In a preferred embodiment, the text-to-speech engine 402 is NeoSpeech, which helps the automated text generator 118 to complete phrases that will be transmitted to the patient. In this embodiment, the automated proactive healthcare service and payer based scheduling system 100 also maintains both the recorded call server 202 and the response computer program 302.

### Screenshots

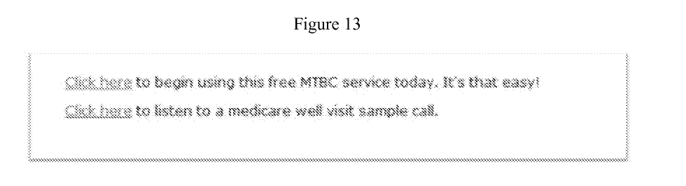

FIG. 13 shows an embodiment of an external source 124. In this embodiment, one external source 124 allows healthcare providers to subscribe to the automated proactive healthcare service and payer based scheduling system 100. Other embodiments of the external source 124 may include but not limited to patient subscription and the like.

The invention disclosed in the above-described embodiments provides an automated proactive scheduling healthcare service and payer based system that filters relevant information, proactively schedules, contacts, and analyzes communication to patients based on the type of healthcare service, payer coverage and scheduling rules. The invention will allow for healthcare providers to streamline the reimbursement process, reduce administrative burdens and schedule appointments. The invention is also able to communicate with patients via electronic communication, voice communication, written communication and the like.

What I claim is:

1. An automated proactive healthcare service and payer based patient scheduling system comprising:
a. at least one computing server having:
i. a local patient database, said local patient database storing patient relevant data,
ii. a local healthcare provider database, said local healthcare provider database storing healthcare provider relevant data,
iii. a healthcare service eligibility computer program, said healthcare service eligibility computer program utilizing a healthcare service coverage rule set and at least one external source,
iv. a payer eligibility computer program, said payer eligibility computer program utilizing patient relevant data,
v. a scheduling rule set, said scheduling rule set proactively scheduling patients.
b. at least one communication server, said at least one communication server having:
i. an automated text generator, said automated text generator generating patient specific messages,
ii. a communication program, said communication program contacting said patient; and
c. said at least one external source maintaining relevant data.

2. The automated proactive healthcare service and payer based patient scheduling system of claim 1 further comprising at least one recorded call server.

3. The automated proactive healthcare service and payer based patient scheduling system of claim 1 wherein said at least one communication server further comprising a response computer program, said response computer program analyzing patient's response.

4. The automated proactive healthcare service and payer based patient scheduling system of claim 1 wherein said at least one communication server further comprising a text to speech engine.

5. An automated proactive healthcare service and payer based patient scheduling system comprising:
a. generating a local patient database, a local healthcare provider database and a healthcare service coverage rule set on at least one computing server;
b. determining healthcare service eligibility on said at least one computing server based on the healthcare service coverage rule set, the local patient database and at least one external source;
c. determining payer eligibility on said at least one computing server based on said at least one external source and a healthcare service eligibility computer program;
d. proactively scheduling patients based on scheduling rule set on said at least one computing server;
e. generating patient specific messages on at least one communication server; and
f. contacting a patient on said at least one communication server.

6. The automated proactive healthcare service and payer based patient scheduling system of claim 5 further comprising a step of recording a call on at least one recorded call server.

7. The automated proactive healthcare service and payer based patient scheduling system of claim 5 further comprising a step of analyzing said patient's response on said at least one communication server.

8. The automated proactive healthcare service and payer based patient scheduling system of claim 5 further comprising a step of translating text to speech on said at least one communication server.

9. An automated proactive healthcare service and payer based patient scheduling system comprising:
a. a first computing server, said first computing server having a local patient database, and a local healthcare provider database;
b. a second computing server, said second computing server having a healthcare service eligibility computer program, said healthcare service eligibility computer program utilizing a healthcare service coverage rule set and at least one external source;
c. a third computing server, said third computing server having a payer eligibility computer program utilizing patient relevant data;
d. a fourth computing server, said fourth computing server having a scheduling rule set, said scheduling rule set proactively scheduling patients;
e. a first communication server, said first communication server having an automated text generator, said automated text generator generating patient specific messages;
f. a second communication server, said second communication server having a communication program, said communication program contacting a patient; and
g. at least one external source, said at least one external source maintaining healthcare data.

10. The automated proactive healthcare service and payer based patient scheduling system of claim 9, further comprising at least one recorded call server.

11. The automated proactive healthcare service and payer based patient scheduling system of claim 9, further comprising a third communication server having a response computer program, said response computer program analyzing said patient's response.

12. The automated proactive healthcare service and payer based patient scheduling system of claim 9, wherein said first communication server comprising a text to speech engine.
